(19) United States
(12) Patent Application Publication
(10) Pub. No.: US 2009/0135390 A1
(43) Pub. Date: May 28, 2009

(54) LITHOGRAPHIC ALIGNMENT MARKS

(75) Inventors: Bruno La Fontaine, Pleasanton, CA (US); Obert R. Wood, II, Loudonville, NY (US); Harry Levinson, Saratoga, CA (US)

Correspondence Address: DITTHAVONG MORI & STEINER, P.C., 918 Prince St., Alexandria, VA, 22314, US

(73) Assignee: Advanced Micro Devices, Inc., Sunnyvale, CA (US)

(21) Appl. No.: 11/944,857

(22) Filed: Nov. 26, 2007

(51) Int. Cl. G03B 27/54

(52) U.S. Cl. 355/67

(57) ABSTRACT

Precise and repeatable alignment performance using asymmetric illumination is achieved by properly structuring, as by segmenting, an alignment mark on a reticle of a photolithographic exposure apparatus as a function of the type of asymmetric illumination, thereby improving resolution and repeatability of an alignment mark formed on a target substrate. Embodiments include double exposure techniques using dipole illumination with an angularly segmented alignment mark, e.g., at 45°, such that the first-order diffracted light is sent at 45° from the initial position of the dipole illumination.

### FIELD OF THE INVENTION

The present invention relates generally to lithographic exposure tools and their use in fabricating semiconductor devices with improved and repeatable alignment performance. The present invention is particularly applicable in fabricating semiconductor devices with dimensions in the deep sub-micron range using aggressive illumination techniques.

### BACKGROUND ART

It is well recognized that the formation of electrical elements within an integrated circuit at smaller sizes and increased densities provides benefits in both performance and functionality. However, as the dimensions of semiconductor device features continue to shrink into the deep sub-micron range, process control windows shrink commensurately. The minimum feature size depends on the chemical and optical limits of a particular lithographic system, and the tolerance for distortions of the shape. Smaller design rules necessitate more accurate and repeatable overlay metrology to ensure adequate levels of device reliability and manufacturing throughput. In addition to the limitations of conventional lithography, the manufacturing cost attendant upon accurately forming ultrafine design features increase, thereby requiring advances in tool design and processing design for efficient use of facilities and high manufacturing throughput.

Various techniques have evolved in an attempt to address problems attendant upon fine feature accuracy and repeatability. For example, there has evolved a method known as optical proximity correction (OPC), which basically involves repeated modification of the exposure reticle and repeated photoresist exposures until the actual pattern form coincides with the design pattern. Various resolution enhancement techniques have also evolved, including aggressive, i.e., off-axis, illumination, such as annular, quadrupole, multipole, and various types of asymmetric illuminations, e.g., dipole illumination. Aggressive or off-axis illumination techniques, such as asymmetric dipole illumination, achieve improved accuracy with respect to feature orientation in one direction or in another direction. However, the end points of lines, such as alignment marks, are not as well defined and/or as easily detectable. For example, complementary dipole exposures make use of off-axis illumination to enhance feature contrast orthogonal to the illumination pole axis at the expense of pattern fidelity in the coordinate direction. Accordingly, features, such as substrate alignment marks, oriented parallel to the illumination pole axis are patterned at a lower quality resulting in degraded alignment along the coordinate direction.

Double exposure techniques have also evolved. However, these techniques have not been completely successful and suffer from low manufacturing throughput, some techniques requiring the repeated use of several tools. Further, in attempting to apply aggressive, off-axis illumination techniques in combination with double exposure techniques, alignment difficulties are greatly exacerbated due to the need to align successive resist patterns.

Accordingly, a need exists for lithographic exposure tools and methodology enabling the fabrication of semiconductor devices having ultrafine features using aggressive, off-axis illumination techniques, such as various types of asymmetric illumination, e.g., dipole illumination. There exists a particular need for such devices and methodology for fabricating semiconductor devices having ultrafine dimensions using aggressive illumination techniques and multiple exposure techniques with precise and repeatable alignment performance.

### DISCLOSURE OF THE INVENTION

An advantage of the present invention is a photolithic exposure apparatus for fabricating semiconductor devices having ultrafine dimensions using aggressive or off-axis illumination with precise and repeatable alignment.

Another advantage of the present invention is a method of fabricating a semiconductor device having dimensions in the deep sub-micron range using aggressive or off-axis illumination techniques with precise and repeatable alignment.

Additional advantages and other features of the present invention will be set forth in the description which follows and in part will be apparent to those having ordinary skill in the art upon examination of the following or may be learned from the practice of the present invention. The advantages of the present invention may be realized and obtained as particularly pointed out in the appended claims.

According to the present invention, the foregoing and other advantages are achieved in part by a photolithographic exposure apparatus comprising: an illumination source for emitting a type of illumination; and a reticle having a reticle alignment mark thereon, the reticle alignment mark being structured depending on the type of illumination such that resolution of a substrate alignment mark on a substrate is enhanced, thereby avoiding degradation of alignment quality in a direction that would otherwise occur using the type of illumination, wherein the substrate alignment mark is different from the reticle alignment mark.

Embodiments include photolithographic exposure apparatuses comprising dipole, quadrupole, multipole, and annular illumination sources. Further embodiments include photolithographic exposure apparatuses containing a dipole illumination source and a reticle having a first segmented alignment mark, such as an alignment mark comprising segments angled at about 40° to about 50°, e.g., to about 43° to about 47°.

Another advantage of the present invention is a method of fabricating a semiconductor device the method comprising: positioning a substrate in a photolithographic exposure apparatus comprising: an illumination source for emitting a type of illumination; and a reticle having a first reticle alignment mark thereon, the first reticle alignment mark being structured depending on the type of illumination such that resolution of a substrate alignment mark to be formed on the substrate is enhanced, thereby avoiding directional alignment degradation that would otherwise occur using the type of illumination, wherein the first reticle alignment mark is different from the substrate alignment mark; and forming a first pattern, including the substrate alignment mark, on the substrate using the first reticle.

Embodiments include methodology wherein the photolithographic exposure apparatus comprises a second reticle having a second reticle alignment mark, and positioning the second reticle in imagewise relationship to the substrate, emitting off-axis illumination, locating the substrate alignment mark, and forming a second pattern over and aligned with respect to the first pattern. The first and second reticle alignment marks may be the same or different depending on the specifics of the off-axis illumination used during first and second exposures.

Another advantage of the present invention is a method of fabricating a semiconductor device using a double exposure technique, the method comprising: positioning a substrate having circuitry thereon in a photolithographic exposure apparatus comprising: a dipole illumination source; a first reticle having a first reticle alignment mark comprising angularly spaced apartment segments; and a second reticle having a second reticle alignment mark; forming a first resist pattern and a substrate alignment mark on the substrate through the first reticle using dipole illumination, wherein the substrate alignment mark is not segmented; forming a second resist pattern on the substrate aligned with respect to the substrate alignment mark, through the second reticle using dipole illumination; and forming a pattern using the first and second resist patterns as a mask.

Embodiments of the present invention include implementing an optical proximity correction (OPC) technique on the reticle alignment mark before forming the first resist pattern.

Additional advantages of the present invention will become readily apparent to those skilled in the art from the followed detailed description, wherein embodiments of the present invention are described, simply by way of illustration of the best mode contemplated for carrying out the present invention. As will be realized, the present invention is capable of other and different embodiments and its several details are capable of modifications in various obvious respects, all without departing from the present invention. Accordingly, the drawings and description are to be regarded as illustrative in nature, and not as restrictive.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 schematically illustrates a photolithographic exposure apparatus in accordance with an embodiment of the present invention.

FIGS. 2a-2c schematically illustrate top views of prior art alignment marks.

FIGS. 3a and 3b schematically illustrate top views of alignment marks, in accordance with an embodiment of the present invention.

FIG. 4 schematically illustrates an exemplary result of a dipole illumination utilizing prior art alignment marks.

FIG. 5 schematically illustrates an exemplary result of a dipole illumination utilizing an alignment mark, in accordance with an embodiment of the present invention.

FIG. 6 schematically illustrates a patterned alignment mark of the FIG. 4 dipole illumination utilizing a prior art alignment mark.

FIG. 7 schematically illustrates a patterned alignment mark of the FIG. 5 dipole illumination utilizing an alignment mark embodiment of the present invention.

### DESCRIPTION OF THE INVENTION

The present invention addresses and solves problems attendant upon fabricating semiconductor devices comprising features with accurately formed dimensions in the sub-100 nanometer range, e.g., with device features of 50 nm and under. The present invention provides photolithographic exposure tools and methodology enabling the formation of various types of semiconductor devices having ultrafine features with high placement accuracy and in an efficient manner, thereby reducing manufacturing costs while increasing device reliability and manufacturing throughput.

Alignment marks are typically provided on a reticle configured to transfer a pattern (or circuit blueprint) to a target layer or substrate. The imaged alignment mark creates corresponding alignment marks on or within a target layer or substrate. As circuit layouts become more complex, successive patterns are used to build up multi-layer structures to enable an IC configuration defined throughout its thickness. It is therefore critical to ensure that a blueprint imaged later in time is properly aligned with one imaged earlier in time. One method to align these sequential patterns is by comparing a relative position between reticle alignment marks and previously imaged alignment marks on a target layer, underlying layer, or substrate.

The relative positioning information is typically referred to as overlay and is more broadly defined as the displacement of a patterned layer from its ideal position aligned to a layer patterned earlier on the device. Overlay can be represented as a two dimensional vector (Δx, Δy) of the substrate surface plane. Tight overlay is becoming more critical to the performance characteristics, reliability, and cost of completed electronic devices.

Conventional approaches include the use of various types of aggressive, off-axis illumination and double exposure techniques. Off-axis illumination, such as asymmetric illumination, enhances the fidelity and accuracy of features; however, the resolution and repeatable use of alignment marks can be degraded. The use of double exposure techniques exacerbates the overlay requirements and alignment problems.

In accordance with embodiments of the present invention, such resolution and alignment difficulties are addressed and solved by forming an alignment mark on a photolithographic exposure tool reticle that is structured or tailored to the particular type of aggressive, off-axis illumination employed. By structuring or tailoring the reticle alignment mark to the aggressive illumination source, resolution and repeatable use of the alignment mark formed on a substrate with the first pattern is enhanced, thereby avoiding degradation of the alignment quality in a direction that would otherwise occur using the type of aggressive illumination.

For example, aggressive or off-axis illumination sources include asymmetric, dipole, quadrupole, multipole, and angular illumination. Such off-axis illumination sources are typically geared for optimizing the ultrafine dimensions of a particular pattern. Such optimization falls short of accurate and repeatable resolution of an alignment mark formed on the substrate using such illumination. Dipole illumination, while suitable for feature orientation in one particular direction or in another particular direction, results in substrate alignment marks that are not well defined in the orthogonal direction, thereby complicating accurate and repeated use of the substrate alignment marks for subsequently deposited layers.

Accordingly, in accordance with an embodiment of the present invention, aggressive resolution enhancement techniques can be effectively employed, such as dipole illumination, with enhanced substrate alignment mark resolution and repeatability, by forming a segmented alignment mark on the reticle, such as an angularly segmented reticle alignment mark, suitably with spaced apart segments angled at about 40° to about 50°, e.g., 43° to about 47°, notably at 45°, such that the first order of defractive light is set at 45° from the initial position of the dipole illumination. In this way the initial pattern is optimized with respect to the features of the pattern while a substrate alignment mark is formed, which is easily and repeatedly resolved during subsequent exposures. In accordance with embodiments of the present invention, an off-axis illumination exposure technique is employed utilizing a plurality of reticles with patterns.

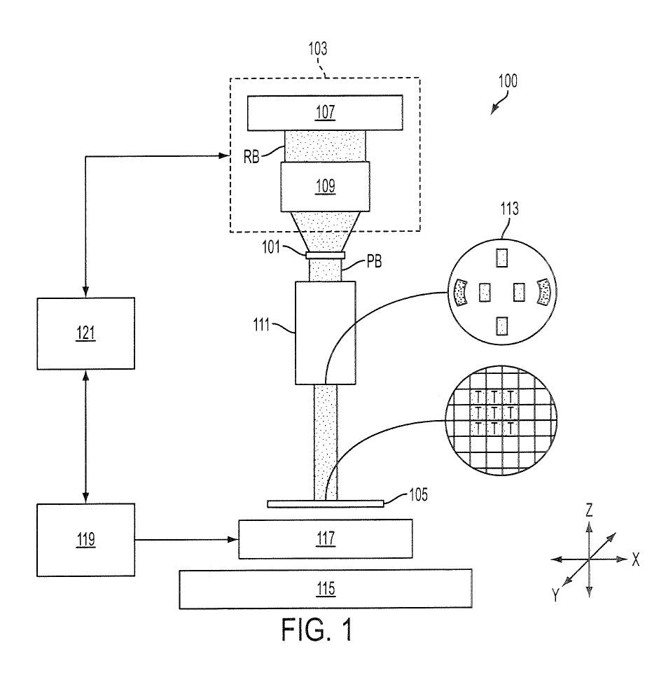

FIG. 1 schematically illustrates a photolithographic apparatus for use in accordance with an embodiment of the present invention. In one particular implementation, the photolithographic exposure apparatus comprises a dipole illumination source or system. While specific reference will be made thereto, it is to be appreciated that the present invention also finds application in other aggressive resolution enhancement techniques, such as annular, quadrupole, and quasar illumination techniques, as well as other non-standard or multiple-exposure methods.

Averting to FIG. 1, photolithographic exposure apparatus 100 comprises a first reticle 101 comprising a design blueprint or pattern incorporating one or more alignment marks that are structured depending on the particular type of asymmetric illumination source 107. Illumination system 103 is configured to project an illumination RB comprising one or more spatial frequencies, e.g., visible, ultraviolet, extreme ultraviolet, x-ray, etc., through reticle 101 onto substrate 105. Illumination beam RB originates from source 107, which may include lasers, diodes, and/or lamps configured to operate within one or more of the spatial frequency ranges. Illumination system 103 may further include various types of optical components 109, such as lenses, filters, beamsplitters, apertures, mirrors, diffusers, plates, polarizers, prisms, windows, or other like optical devices, as well as combinations thereof, for bending, splitting, focusing, diffusing, reflecting, refracting, collecting, polarizing, or otherwise altering or controlling illumination beam RB.

In embodiments of the present invention incorporating an off-axis illumination scheme, such as dipole illumination, illumination system 103 may also be configured to reduce or eliminate “on-axis” components of illumination beam RB striking reticle 101. In this manner, one or more poles of illumination beam RB can be made incident upon reticle 101, wherein the angle of incidence for any given pole is tilted (or rotated) away from the normal extending from the X-Y plane. In other instances, illumination system 103 may include an adjuster, integrator, or condenser for modifying and conditioning the angular intensity distribution and uniformity of illuminating beams.

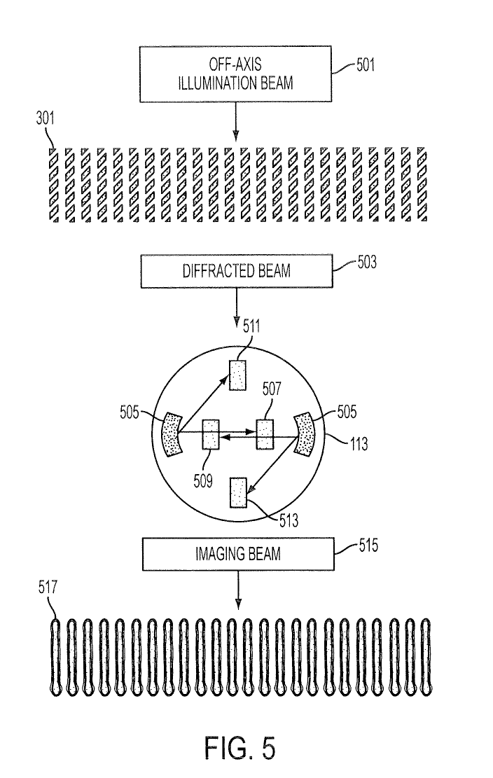

Incident illumination beams may be patterned by reticle 101 to create diffracted beam PB for imaging substrate 105. In accordance with an embodiment of the present invention, an angularly segmented alignment mark, such as that illustrated in FIG. 5, is formed for enhanced and repeatable resolutions. Diffracted beam PB is “collected” (or combined) by a projection lens system 111 configured to project the diffracted beam PB onto one or more target areas T (e.g., one or more dies) of substrate 105. Lens pupil 113 illustrates diffracted beam orders collected by projection lens system 111 just before projection onto substrate 105. It is contemplated that any appropriate projection lens system 111 may be used.

With continued reference to FIG. 1, apparatus 100 also includes support structure 115, a conventional substrate table 117, table control module 119 and alignment system 121.

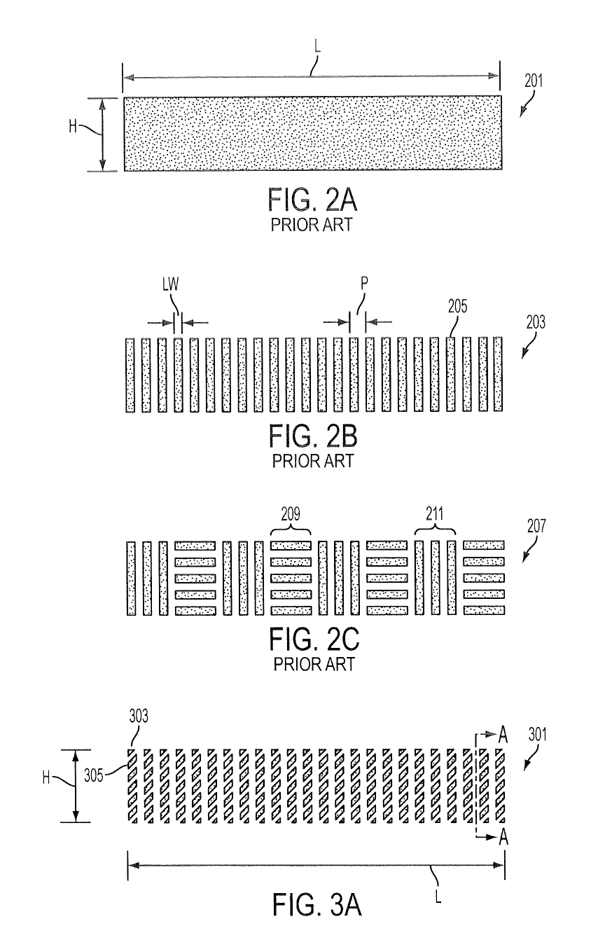

FIG. 2a schematically illustrates a top view of a prior art alignment mark. As shown, alignment mark 201 comprises a solid rectangular bar of height H and length L. Typically, the dimensioning of alignment mark 201 is on a substantially larger scale than the device features imaged on a target layer. For example, alignment mark 201 may be formed having dimensions an order of magnitude larger than the smallest dimensional feature patterned on a target layer. Accordingly, when alignment mark 201 is patterned to the target layer, light diffracted by an alignment mark on a reticle will propagate along a dissimilar path through the projection optics of a lithography system than the light diffracted by the patterned device features. As such, images of alignment mark 201 will be subjected to different aberrations than the images of the device features. In this manner, it is possible for overlay errors of alignment mark 201 to be dissimilar to the overlay errors of the patterned device features. Furthermore, relative vibrations between components of a lithographic apparatus, such as those produced by high-acceleration substrate handlers, blur images produced by alignment mark 201. In either instance, accurate overlay cannot be reliably assured.

In order to improve overlay error similarities and image stability, alignment mark 201 may be segmented into a grating having similar line width and pitch as those features comprising a circuit pattern. Averting to FIG. 2b, a top view of a prior art segmented alignment mark is schematically illustrated. Alignment mark 203 comprises a line-and-space pattern formed through a plurality of parallel, linear segments, e.g., segment 205, separated by pitch P. Further, individual segments are dimensioned having line width LW. In this manner, LW and P are sized similarly to the features of a circuit pattern. During alignment procedures; however, alignment mark 203 only exhibits comparable overlay errors to device features being similarly oriented.

By developing alignment pattern topographies having grating segments in both the horizontal and vertical orientations, individual x-alignment and y-alignment information may be obtained. FIG. 2c schematically illustrates a top view of a prior art alignment mark having such orientations. Alignment mark 207 comprises alternating sub-gratings of the horizontal and vertical orientations, e.g., sub-grating 209 and 211, respectively. In this manner, horizontal sub-gratings are used to aid alignment in the x-direction, while vertical sub-gratings are used to aid alignment in the y-direction.

Limitations associated with alignment mark 207 occur in conjunction with various off-axis illumination techniques, such as dipole illumination. As known, dipole illumination is one of the more attractive resolution enhancement techniques due to its high image contrast for dense pitches and superior resolution capabilities. This extreme case of off-axis illumination is capable of improved process latitude at very low k₁ imaging. In this manner, however, dipole illuminations only enhance feature resolution orthogonal to the illumination pole axis. Coordinate features, on the other hand, may loose some or all of their imaging contrast. As a result, reticle patterns are typically decomposed into horizontal and vertical orientations in order to take full advantage of the technique.

Once converted, a vertical exposure (Y-pole axis) is utilized to image horizontally oriented features, and a horizontal (X-pole axis) exposure is utilized to image vertically oriented features. Depending on the illumination pole-axis, either the horizontal or vertical sub-gratings of alignment mark 207 will loose some or all of their imaging contrast and/or fidelity. Degraded imaging contrast and/or fidelity hinder the alignment of subsequent exposures and can increase the possibility of concomitant overlay errors. Unacceptable overlay often necessitates rework or scrap, which increases manufacturing costs and decreases manufacturing throughput.

Embodiments of the present invention enable the fabrication of semiconductor chips comprising optimized alignment marks capable of accurate patterning in each direction of an off-axis illumination technique. Embodiments of the present invention achieve this result by optimizing a plurality of alignment marks to exhibit complementary aspects, which enables a greater amount of illumination to be collected at a pupil lens independent of the illumination pole-axis being utilized.

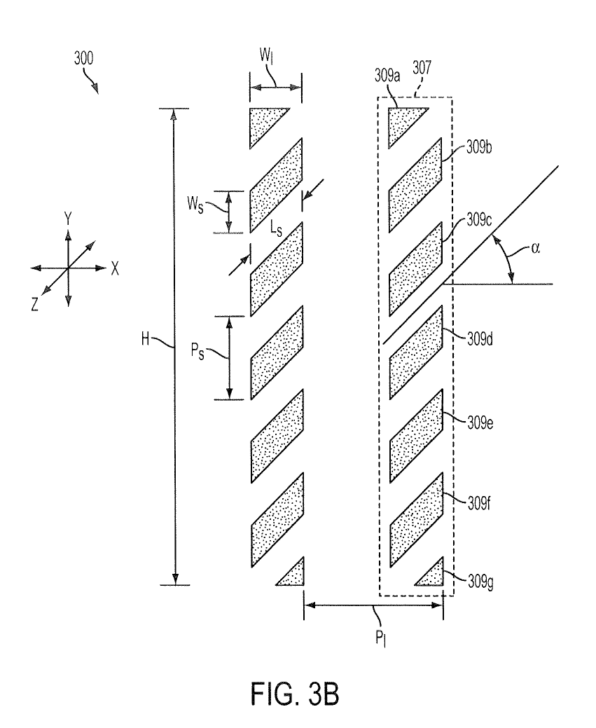

FIGS. 3a and 3b schematically illustrate top views of optimized alignment marks, according to various embodiments of the invention. Optimized alignment marks (hereinafter “mark”) 301 are suitable for image or diffraction based overlay measurement techniques. In essence, mark 301 can be patterned on or to a reticle (or other patterning device) for use in one or more lithographic apparatuses, including those previously described. As depicted, mark 301 consists of a plurality of linear grating lines, e.g., grating line 303, further divided into a plurality of segments, e.g., grating segment 305. The overall dimensions of mark 301 may have length L=1 to 5 μm and height H=0.5 to 1 μm. When patterned to a target layer or substrate, a patterned alignment mark may be fabricated anywhere on or in substrate 105 (FIG. 1), such as a target area T, a space between target areas T, a kerf region, a scribe-line, and/or any combination thereof. Such patterned alignment marks will be explained in greater detail according to FIGS. 5 and 7.

Apart from its depicted form, mark 301 may comprise segmented grating lines in both the horizontal and vertical orientations, as well as angled there between. In other embodiments, mark 301 may be included in a pattern or matrix of other similar (or dissimilar) marks or comprise a portion of a larger alignment mark. In still other embodiments, portions of mark 301 may be utilized to design other geometric figures or patterns, such as a box, a cross, a cross-in-box, etc. In particular implementations, a plurality of staggered rows and columns of mark 301 may be provided in an array. In essence, optimized alignment marks of the present invention are limited only to those patterns capable of being manufactured. As such, almost any conceivable design or pattern may comprise an embodiment of mark 301.

FIG. 3b schematically illustrates an enlarged view of the trailing portion of optimized alignment mark 301 taken at section A-A, according to an embodiment of the present invention. As illustrated, individual grating lines, e.g., grating line 307, of mark 301 incorporate a predefined number of grating segments, e.g., segments 309a-g. While only five full segments (segments 309b-f) and two partial segments (segments 309a and 309g) are depicted, it is contemplated that any number of full and/or partial segmentations may be included. The same is true for grating lines of mark 301.

Individual grating lines are similarly included on or within a base structure 300, e.g., a reticle, mask, or other patterning device. Grating lines have length H, width W₁, and thickness T (extending into the page) and are separated at pitch P₁. In exemplary embodiments, grating line dimensions and spacing may vary according to the following: H=0.5 to 1 μm, W₁=0.05 to 0.3 μm, T=50 to 3,000 Å and P₁=0.2 to 1 μm, ranging from GG to HH nm. In alternative embodiments, grating line dimensions and/or spacing may vary along the height, length, or thickness of mark 301. For instance, grating lines might take the form of trapezoids instead of rectangles. In other implementations, the dimensions and/or spacing may periodically vary, such as in a sinusoidal configuration, or vary as one or more arrays.

Meanwhile, grating segments may be fabricated having dimension Wₛ, ranging from 40 to 80 nm, and separated at pitch Pₛ, varying from 80 to 200 nm. The length Lₛ of a grating segment will vary from H to W₁ depending upon an angle of rotation, i.e., α=0° to ±90°, e.g., ±20° to ±70°, such as ±40° to ±50°, including ±43° to ±47°, from the horizontal, of the grating segment in question. In alternative embodiments, grating segment dimensions, spacing, and/or angle of rotation may vary along the height, length, or thickness of mark 301. In other implementations, the dimensions, spacing, and/or angle of rotation may periodically vary, such as in a sinusoidal configuration, or vary as one or more arrays.

Typically, an initial pattern is formed on a substrate using aggressive illumination techniques, such as dipole illumination, designed to optimize the accuracy and orientation of the features of the pattern. Accordingly, when forming an initial pattern containing an alignment mark, embodiments of the present invention comprise forming optical proximity correction (OPC) on the alignment mark for optimization.

In one particular embodiment, mark 301 can be optimized for dipole illumination having similar grating lines and grating segments and dimensions according to the following: H=1 μm, L=5 μm, W₁=75 nm, P₁=150 nm, Wₛ=50 nm, Pₛ=100 nm, α=45° and T=500 Å. As such, when either an X or Y-pole axis illumination is incident upon alignment mark 301, the first-order of diffraction will be sent 45° from the initial position of the dipole. Accordingly, projection lens system 111 will be able to collect more orders of diffraction independent of the illumination pole axis, i.e., more of illumination beam RB will be collected and in a consistent amount despite the illumination pole axis being utilized. Thus, embodiments of the present invention have the advantage of an optimized grating efficiency that provides significant improvements in patterning contrast and fidelity.

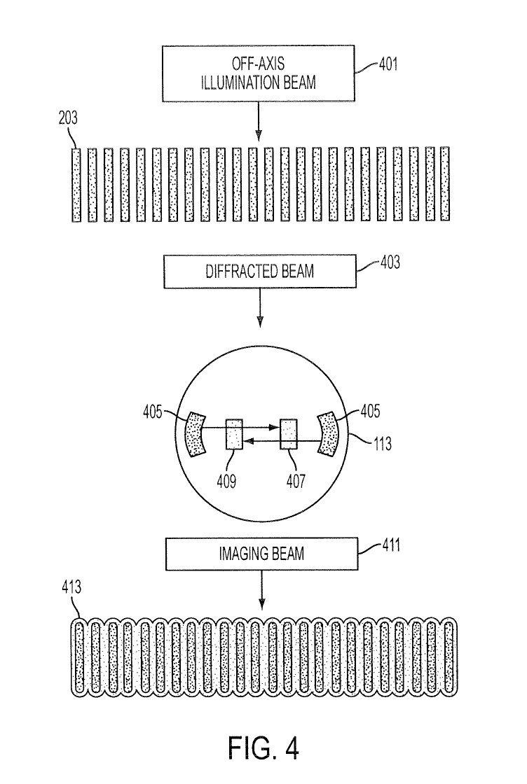

FIG. 4 schematically illustrates an exemplary result of a dipole illumination utilizing prior art alignment marks. As illustrated, an off-axis illumination beam 401, i.e., X-pole illumination, is incident upon segmented alignment mark 203 of a patterning device. Illumination beam 401 is diffracted by the patterning device resulting in diffracted beam 403, whereby only the zero order 405 and the first orders 407 and 409 are captured by projection lens system 111 and collected at pupil 113. Projection lens system 111 projects the imaging beam 411 onto a target layer of resist coated to substrate 105, thereby imaging patterned alignment marks 413 to the target layer.

FIG. 5 schematically illustrates an exemplary result of dipole illumination of optimized alignment marks, in accordance with an embodiment of the present invention. As illustrated, an off-axis illumination beam 501, i.e., X-pole illumination, is incident upon optimized alignment marks 301 of a patterning device. Illumination beam 501 is diffracted by the patterning device resulting in diffracted beam 503, whereby the zero order 505, the first orders 507 and 509, and the second orders 511 and 513 and can be captured by projection lens system 111 and collected at pupil 113. Projection lens system 111 projects an imaging beam 515 onto a target layer of resist coated to substrate 105, thereby imaging patterned alignment marks 517 to the target layer.

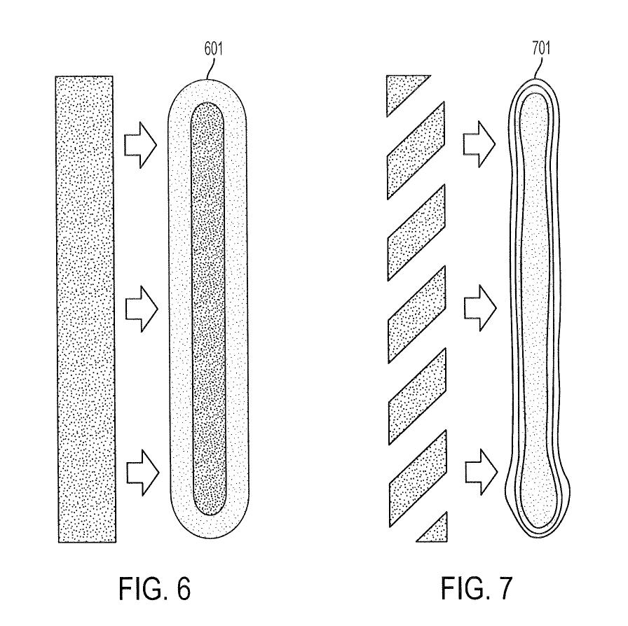

FIGS. 6 and 7 compare the patterned alignment marks of FIGS. 4 and 5, respectively. As depicted, patterned alignment mark 701 exhibits better contrast and fidelity than patterned alignment mark 601. This is a result of the additional orders of diffraction collected on pupil 113 and projected to substrate 105 by projection lens system 111. During alignment procedures, alignment system 121 can effectuate tighter overlay since the patterned alignment marks are more accurately formed with less distortions of shape. Therefore, embodiments of the present invention enable the fabrication of semiconductor chips comprising optimized alignment marks capable of accurate patterning in each direction of an off-axis illumination technique. Furthermore, various embodiments enable precise formation of alignment marks capable of improving manufacturing efficiencies, lowering costs, and increasing device reliability and manufacturing throughput.

The present invention can be employed in the fabrication of semiconductor chips comprising any of various types of semiconductor devices, including semiconductor memory devices, such as eraseable, programmable, read-only memories (EPROMs), electrically eraseable programmable read-only memories (EEPROMs), and flash eraseable programmable read-only memories (FEPROMs). Semiconductor chips fabricated in accordance with embodiments of the present invention can be employed in various commercial electronic devices, such as computers, cellular telephones and digital cameras, and can easily be integrated with printer circuit boards in a conventional manner.

The present invention enables the efficient fabrication of semiconductor chips comprising devices with accurately aligned design features with high manufacturing throughput. The present invention enjoys industrial applicability in fabricating semiconductor chips useful in any of various types of industrial applications, including chips having highly integrated semiconductor devices, including flash memory semiconductor devices exhibiting increased circuit speed.

In the proceeding description, the present invention is described with reference to specifically exemplary embodiments thereof. It will, however, be evident that various modifications and changes may be made thereto without departing from the broader spirit and scope of the present invention, as set forth in the claims. The specification and drawings are, accordingly, to be regarded as illustrative and not as restrictive. It is understood that the present invention is capable of using various other combinations and embodiments and is capable of any changes or modifications within the scope of the inventive concept as expressed herein.

What is claimed is:

1. A photolithographic exposure apparatus comprising:
an illumination source for emitting a type of illumination; and
a reticle having a reticle alignment mark thereon, the reticle alignment mark being structured depending on the type of illumination such that resolution of a substrate alignment mark on a substrate is enhanced, thereby avoiding degradation of alignment quality in a direction that would otherwise occur using the type of illumination, wherein the substrate alignment mark is different from the reticle alignment mark.

2. The apparatus according to claim 1, wherein the substrate alignment mark on the substrate was made using the reticle.

3. The apparatus according to claim 1, wherein the illumination source emits off-axis illumination.

4. The apparatus according to claim 3, wherein the illumination source emits dipole illumination.

5. The apparatus according to claim 4, wherein the reticle alignment mark is segmented.

6. The apparatus according to claim 5, wherein the reticle alignment mark is angularly segmented.

7. The apparatus according to claim 6, wherein the segments are angled at about 40° to about 50° from an imaginary horizontal line orthogonal to the reticle alignment mark.

8. The apparatus according to claim 3, wherein the illumination source emits quadrupole illumination.

9. The apparatus according to claim 3, wherein the illumination source emits quasar illumination.

10. The apparatus according to claim 3, wherein the illumination source emits annular illumination.

11. A method of fabricating a semiconductor device, the method comprising:
positioning a substrate in a photolithographic exposure apparatus comprising:
an illumination source for emitting a type of illumination; and
a first reticle having a first reticle alignment mark thereon, the first reticle alignment mark being structured depending on the type of illumination such that resolution of a substrate alignment mark to be formed on the substrate is enhanced, thereby avoiding directional alignment degradation that would otherwise occur using the type of illumination, wherein the first reticle alignment mark is different from the substrate alignment mark; and
forming a first pattern, including the substrate alignment mark, on the substrate using the first reticle.

12. The method according to claim 11, wherein the illumination source emits off-axis illumination.

13. The method according to claim 12, wherein the first reticle alignment mark is segmented.

14. The method according to claim 12, wherein the illumination source emits dipole illumination.

15. The method according to claim 14, wherein the first reticle alignment mark is angularly segmented.

16. The method according to claim 15, wherein the first reticle alignment mark comprises segments angled at about 40° to about 50° from an imaginary horizontal line orthogonal to the first reticle alignment mark.

17. The method according to claim 11, wherein the illumination source emits dipole illumination, quadrupole illumination, quasar illumination, or angular illumination.

18. The method according to claim 11, wherein the photolithographic exposure apparatus comprises a second reticle having a second reticle alignment mark, the method comprising:
positioning the second reticle in imagewise relationship to the substrate;
emitting off-axis illumination;
locating the substrate alignment mark; and
forming a second pattern over and aligned with respect to the first pattern.

19. A method of fabricating a semiconductor device using a double exposure technique, the method comprising:
positioning a substrate having circuitry thereon in a photolithographic exposure apparatus comprising:
a dipole illumination source;
a first reticle having a first reticle alignment mark comprising angularly spaced apart segments; and
a second reticle having a second reticle alignment mark; and
forming a first resist pattern and a substrate alignment mark on the substrate through the first reticle using dipole illumination, wherein the substrate alignment mark is not segmented;
forming a second resist pattern on the substrate, aligned with respect to the substrate alignment mark, through the second reticle using dipole illumination; and
forming a pattern using the first and second resist patterns as a mask.

20. The method according to claim 19, further comprising implementing an optical proximity correction (OPC) technique on the first reticle alignment mark, before forming the first resist pattern.
